(19) United States
(12) Patent Application Publication
(10) Pub. No.: US 2012/0152377 A1
(43) Pub. Date: Jun. 21, 2012

(54) FLUID BYPASS VALVE SYSTEM

(75) Inventors: Joseph E. Tabor, Eureka, IL (US); Christopher M. Gruel, Edwards, IL (US)

(73) Assignee: Caterpillar Inc., Peoria, IL (US)

(21) Appl. No.: 12/972,580

(22) Filed: Dec. 20, 2010

(51) Int. Cl. F16K 31/12

(52) U.S. Cl. 137/487.5

(57) ABSTRACT

A fluid bypass valve system includes a blocking valve having an inlet, an outlet, and a vent. The blocking valve is configured to allow a fluid to pass from the inlet to the outlet when there is a fluid pressure drop from the inlet to the vent. An electro-mechanical valve having a first fluid path and a second fluid path is configured to toggle between the first fluid path and the second fluid path in response to an electrical signal. A fluid conduit couples the blocking valve to the electro-mechanical valve such that the vent is communicatively coupled to an area of lower pressure via the first fluid path and receiving fluid via an orifice path when the electro-mechanical valve is toggled to the first fluid path, and such that the vent is communicatively coupled to an area of higher pressure fluid via the orifice path and via an additional path when the electro-mechanical valve is toggled to the second fluid path.

### TECHNICAL FIELD

This disclosure relates generally to a system and apparatus having a working fluid processing circuit (e.g., a hydraulic system) and, more particularly, to a bypass valve system for the fluid processing circuit.

### BACKGROUND

Many machines such as tractors, loaders, graders, and etc., use fluid hydraulic systems to perform work using a pressurized fluid. One problem with this type of system is that it imposes a parasitic load on the engine and starting system when the engine of the machine is started. This load causes the machine to require more starting power. For example, the machine may require a larger starter motor and/or a larger battery to over come the load and start the engine. As such, this adds cost to the machine and reduces machine overall efficiency.

To reduce this load applied to the machine engine at start-up, some machines bypass the hydraulic system using a mechanical pilot valve during machine start-up to divert the fluid around the hydraulic system and thereby reduce pressure of the fluid in the system. This, in turn, reduces the load on the engine, the starter motor, and the battery at start-up.

The machine hydraulic system is generally not usable until the mechanical pilot valve in the bypass system resets after start-up of the machine and thus, allows the working fluid to flow to the hydraulic work system. The pilot valve actuates to bypass the hydraulic work system when a fluid pressure drop is present between an inlet and a vent of the pilot valve. The pilot valve resets after receiving a pressurized fluid at the valve's vent via a restrictive orifice thereby canceling the pressure drop. However, in cold climates (e.g., approximately −30° F. or below) the fluid becomes very viscous and is slow to pass through the restrictive orifice to cancel the pressure drop. Because of the viscosity of the fluid at low temperatures and because the pilot valve traditionally only resets by receiving fluid via the restrictive orifice path, the mechanical pilot valve is slow to reset after start-up of the machine. Thus, an operator must wait for the mechanical pilot valve to reset to begin using the machine. This causes unwanted down time for the machine.

In view of the above, it would be desirable to provide a fluid bypass valve system that resets faster in cold temperatures and allows the operator to use the machine sooner. Thus, the present disclosure is directed to overcoming one or more of the problems as set forth above.

### SUMMARY

In one aspect of the present disclosure a fluid bypass valve system includes a blocking valve having an inlet, an outlet, and a vent. The blocking valve is configured to allow a fluid to pass from the inlet to the outlet when there is a fluid pressure drop from the inlet to the vent. The fluid bypass valve system also includes an electro-mechanical valve having a first fluid path and a second fluid path. The electro-mechanical valve is configured to toggle between the first fluid path and the second fluid path in response to an electrical signal. A fluid conduit couples the blocking valve to the electro-mechanical valve such that the vent is communicatively coupled to an area of lower pressure via the first fluid path and receiving fluid via an orifice path when the electro-mechanical valve is toggled to the first fluid path. The fluid conduit also couples the blocking valve to the electro-mechanical valve such that the vent is communicatively coupled to an area of higher pressure fluid via the orifice path and via an additional path when the electro-mechanical valve is toggled to the second fluid path.

In another aspect of the present disclosure a hydraulic working fluid system includes a fluid reservoir, a fluid pump, a work system, and a fluid bypass valve system. The fluid reservoir includes a fluid. The fluid pump receives the fluid from the fluid reservoir and is configured to pressurize the fluid. The work system receives the fluid in a pressurized state from the fluid pump and is configured to perform work using the fluid and return the fluid to the fluid reservoir. A fluid bypass valve system is parallel to the work system between the fluid pump and the fluid reservoir and is configured to selectively bypass the fluid around the work system and then quickly reset the bypass valve system.

### BRIEF DESCRIPTION OF THE DRAWINGS

FIG. 1 illustrates a block diagram of an embodiment of a hydraulic working fluid processing system according to the present disclosure.

FIGS. 2 and 3 illustrate schematic diagrams of an embodiment of a fluid bypass valve system for the fluid processing system of FIG. 1, at different stages of operation.

### DETAILED DESCRIPTION

The present disclosure relates generally to a system and apparatus having a working fluid processing circuit, such as a hydraulic circuit. More specifically, the present disclosure provides a bypass valve system for a fluid processing circuit. The systems described herein are contemplated to operate within various machines, such as wheel loaders, motor graders, tractors, and any other type of machine suitable for using working fluid processing circuits.

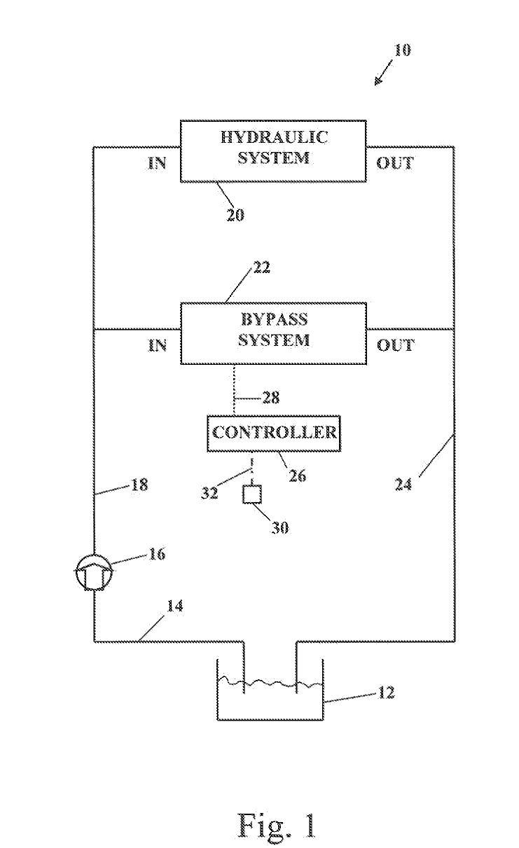

FIG. 1 illustrates a block diagram of an embodiment of a fluid processing system 10 according to the present disclosure. One example of a working fluid processing circuit 10 is a hydraulic system that uses a hydraulic oil/fluid from a fluid reservoir, pressurizes the fluid, performs work using the pressurized fluid, and then returns the fluid to the reservoir to be re-used.

As shown in FIG. 1, a fluid reservoir 12 provides a holding tank for the working fluid. A fluid conduit 14 is communicatively coupled to a fluid pump 16 and provides a path for the fluid to travel from the reservoir 12 to the fluid pump 16. The fluid in the conduit 14 is generally at a low pressure (e.g., a suction line) when the fluid pump 16 is operating. The fluid pump 16 draws the fluid from the reservoir 12 and pressurizes it to a pressure level suitable for providing work via the fluid processing system 10, as should be readily understood by those ordinarily skilled in the art.

A fluid conduit 18 communicates the pressurized fluid from the fluid pump 16 to a hydraulic work system 20. The work system 20 receives the pressurized fluid and may perform work functions using the pressurized fluid in working fluid devices, such as hydraulic cylinders, hydraulic motors, and other working fluid devices (not shown). After using the pressurized fluid, the work system 20 returns the fluid back to the fluid reservoir 12 via a low pressure fluid conduit 24. This fluid flow cycle may be performed over and over as desired.

It may be desirable to bypass the fluid in the fluid processing system 10 around the hydraulic work system 20. For example, when a machine such as a wheel loader or a motor grader (not shown) having the fluid processing system 10 is started-up, the work system 20 provides a parasitic load on the starting system of the machine. Reducing this parasitic load may increase overall efficiency of the machine and may allow for the starting systems of the machine to be made smaller and thus, at a lower cost.

Accordingly, a fluid bypass valve system 22 is provided in the fluid processing system 10 parallel to the hydraulic work system 20. As such, the fluid bypass valve system 22 provides a path for the fluid to return from the fluid pump 16 to the fluid reservoir 12 without going through the hydraulic work system 20.

In an embodiment, a controller 26 controls operation of the fluid bypass valve system 22 by providing an electrical signal via a control signal electrical line 28 to manipulate (e.g., turn-on and turn-off) the fluid bypass valve system 22. The controller 28 is logic controller and may include a computer readable medium capable of receiving, storing and retrieving information, algorithms, and other data. The controller may receive an input from a sensor 30 via sensor signal electrical line 32. The sensor 30 may be configured to sense when the machine is being started-up and thereby cause the fluid to bypass hydraulic work system 20 during that start-up time and for a time thereafter. In other embodiments, the sensor 30 may be configured to sense temperature, atmospheric pressure, altitude, time, and/or other sensory inputs. In addition, the controller 26 may receive input signals from a number of sensors and provide control signals for the bypass system 22 per an algorithm incorporating the multiple inputs.

### INDUSTRIAL APPLICABILITY

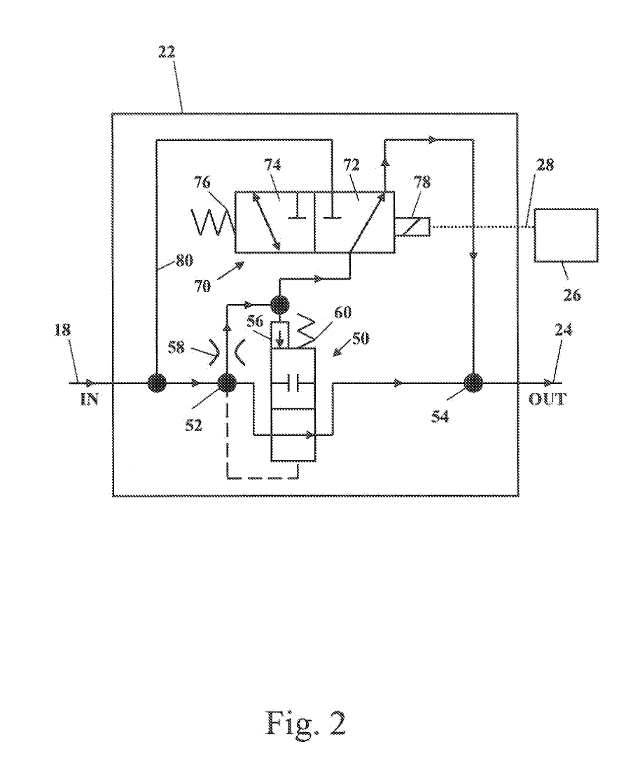

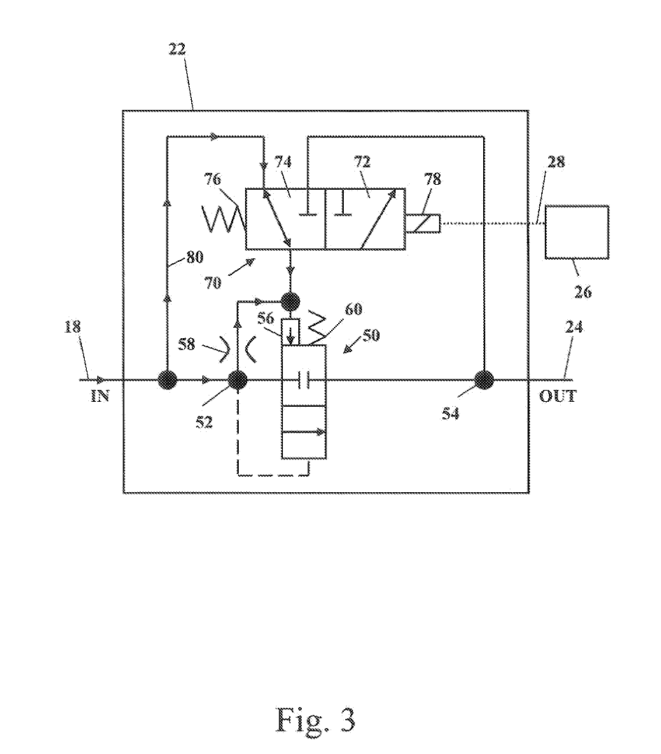

FIGS. 2 and 3 illustrate schematic diagrams of the fluid bypass valve system 22 for the fluid processing system 10 at different stages of operation. Specifically, FIG. 2 shows a fluid flow through the fluid bypass valve system 22, and thereby allowing the fluid to bypass the hydraulic work system 20. Conversely, FIG. 3 shows a fluid flow for the fluid bypass valve system 22 resetting after losing the control signal from the controller 26 and thereby blocking flow of the fluid through the fluid bypass valve system 22 so that the fluid will then pass through the hydraulic work system 20.

Referring still to FIGS. 2 and 3, the fluid bypass valve system 22 includes a mechanical blocking valve 50 and an electro-mechanical valve 70 coupled together in fluid communication with one another. The blocking valve 50 has an inlet at 52, an outlet at 54, and a vent at 56. An orifice 58 provides a fluid restriction for fluid flowing from the conduit 18 toward the vent 56. This restriction allows the fluid in the conduit 18 to be at a higher fluid pressure than the fluid in the conduit 24. This creates a pressure drop between the inlet 52 and the vent 56. The blocking valve 50 includes a biasing device 60, such as a spring, that biases the blocking valve 50 as closed between the inlet 52 and the outlet 54 at its “at rest” position. This is shown in FIG. 3. However, when there is a sufficient pressure drop between the inlet 52 and the vent 56 to overcome the biasing device 60, the blocking valve 50 allows fluid to pass from the inlet 52, though the valve 50 to the outlet 54. One example of a blocking valve 50 is a HydraForce™ EV20-S34 directional valve. However, other valves may be used with the present disclosure.

The electro-mechanical valve 70 includes a first fluid path 72 and a second fluid path 74 configured to allow fluid to pass through the respective path 72/74 when the electro-mechanical valve 70 is toggled toward that path 72/74. The electro-mechanical valve 70 includes a biasing device 76, such as a spring, that biases the electro-mechanical valve toward the second fluid path 74 such that when the electro-mechanical valve 70 is in its “at rest” state, fluid may pass through the second fluid path 74 and not through the first fluid path 72, as is shown in FIG. 3.

To toggle the electro-mechanical valve 70 between the first fluid path 72 and the second fluid path 74, the electro-mechanical valve 70 includes an electro-mechanical solenoid 78. The solenoid 78 receives an electrical control signal from the controller 26 via the control signal electrical line 28. When the electrical signal is received by the solenoid 78, the solenoid converts the electrical signal to mechanical motion which overcomes the biasing device 76 and thus, toggles the electro-mechanical valve from the second fluid path 74 toward the first fluid path 72 so that fluid may pass through the first fluid path 72, as shown in FIG. 2.

In operation, the sensor 30 senses a condition (e.g., machine engine starting, temperature, pressure, etc.) at which that the fluid in the working fluid processing system 10 should bypass the hydraulic system 20. The condition sensed by the sensor 30 is received by the controller 26. The controller 26 then generates an electrical bypass signal and communicates that to the solenoid 78 of the electro-mechanical valve 70. In response to that electrical signal, the electro-mechanical valve 70 toggles toward the first fluid path 72.

Having the electro-mechanical valve 70 toggled toward the first fluid path 72 allows the higher pressure fluid in the conduit 18 to pass through the inlet 52 and through the orifice 58 to the vent 56. Because the fluid at the vent 56 passes through the restrictive orifice 58 and because the fluid at the vent is communicated to the low pressure conduit 24 via the first fluid path 72 of the electro-mechanical valve 70, this creates a pressure drop in the blocking valve 50 from the inlet 52 to the vent 56. When this pressure drop is enough to overcome the biasing force of the biasing device 60, which allows the fluid to flow from the conduit 18 to the conduit 24 through the blocking valve 50. Accordingly, this allows the fluid to bypass the hydraulic work system 20. In other words, when the controller 26 determines that the fluid is to bypass the hydraulic work system 20, the fluid passes along the routes shown having arrows from the conduit 18 to the conduit 24 in FIG. 2.

When the controller 26 determines that the condition for bypassing the hydraulic work system 20 is no longer present, the controller 26 communicates with the solenoid 76 of the electro-mechanical valve 70 to toggle back toward the second fluid path 74 (e.g., the valve's “at rest” position). When the electro-mechanical valve 70 toggles back to the second fluid path position 74, fluid flows from the high pressure conduit 18 to the vent 56 of the blocking valve 50 via the orifice 56 path and via the additional path 80 as shown by the arrows in FIG. 3. The additional path 80 is less restrictive than the orifice 56 path and allows the cold, viscous oil to flow to the vent 56 much quicker than only providing the fluid through an orifice to the vent, as was on conventional systems. Once the fluid flows to the vent 56, the pressure at the inlet 52 and the vent 56 are able to substantially equalize and thus, no longer overcome the biasing of the biasing device 60. As a result, the blocking valve 50 closes and blocks flow of the fluid through the blocking valve 50 and through the fluid bypass valve system 22. As a result, providing an additional path (e.g., path 80) for the fluid to flow to the vent 56 when bypassing the hydraulic work system 20 is no longer desired allows for a reduced reset time for the fluid bypass valve system 22.

Other aspects of the present disclosure can be obtained from a study of the drawings, the specification, and the appended claims. For example, it should be understood that other valves and conduit systems may be embodied in the present disclosure to provide an additional fluid path for resetting the blocking valve when bypassing the hydraulic work system 20 is no longer desired. As another example, the system may be configured to be energized when fluid bypass is not desired, rather than when fluid bypass is desired.

It will be apparent to those skilled in the art that various modifications and variations can be made to the disclosed fluid bypass valve system. Other embodiments will be apparent to those skilled in the art from consideration of the specification and practice of the disclosed fluid bypass valve system. It is intended that the specification and examples be considered as exemplary only, with a true scope being indicated by the following claims and their equivalents.

What is claimed is:

1. A fluid bypass valve system comprising:
a blocking valve having an inlet, an outlet, and a vent, the blocking valve configured to allow a fluid to pass from the inlet to the outlet when there is a fluid pressure drop from the inlet to the vent;
an electro-mechanical valve having a first fluid path and a second fluid path, the electro-mechanical valve configured to toggle between the first fluid path and the second fluid path in response to an electrical signal; and
a fluid conduit coupling the blocking valve to the electro-mechanical valve such that the vent is communicatively coupled to an area of lower pressure fluid via the first fluid path and receiving fluid via an orifice path when the electro-mechanical valve is toggled to the first fluid path, and such that the vent is communicatively coupled to an area of higher pressure fluid via the orifice path and via an additional path when the electro-mechanical valve is toggled to the second fluid path.

2. The fluid bypass valve system of claim 1, wherein the vent being communicatively coupled to the area of lower pressure fluid causes the fluid pressure drop from the inlet to the vent.

3. The fluid bypass valve system of claim 1, further comprising a controller configured to provide the electrical signal to the electro-mechanical valve.

4. The fluid bypass valve system of claim 3, further comprising a sensor device coupled to the controller, the sensor providing a signal to the controller relating to one of temperature, atmospheric pressure, and altitude.

5. The fluid bypass valve system of claim 1, wherein the blocking valve is configured to be biased as closed between the inlet and the outlet.

6. The fluid bypass valve system of claim 1, electro-mechanical valve is configured to be biased toward the second fluid path.

7. A hydraulic working fluid system comprising:
a fluid reservoir, including a fluid;
a fluid pump receiving the fluid from the fluid reservoir and configured to pressurize the fluid;
a work system receiving the fluid in a pressurized state from the fluid pump and configured to perform work using the fluid and return the fluid to the fluid reservoir; and
a fluid bypass valve system in parallel to the work system between the fluid pump and the fluid reservoir, the fluid bypass valve system including;
a blocking valve having an inlet, an outlet, and a vent, the blocking valve configured to allow the fluid to pass from the inlet to the outlet when there is a fluid pressure drop from the inlet to the vent;
an electro-mechanical valve having a first fluid path and a second fluid path, the electro-mechanical valve configured to toggle between the first fluid path and the second fluid path in response to an electrical signal; and
a fluid conduit coupling the blocking valve to the electro-mechanical valve such that the vent is communicatively coupled to an area of lower pressure fluid via the first fluid path and receiving fluid via an orifice path when the electro-mechanical valve is toggled to the first fluid path, and such that the vent is communicatively coupled to an area of higher pressure fluid via the orifice path and via an additional path when the electro-mechanical valve is toggled to the second fluid path.

8. The hydraulic fluid system of claim 7, wherein the inlet receives the fluid from the fluid pump and wherein the outlet communicates the fluid to the fluid reservoir.

9. The hydraulic fluid system of claim 7, wherein the vent being communicatively coupled to the area of lower pressure fluid causes the fluid pressure drop from the inlet to the vent.

10. The hydraulic fluid system of claim 7, further comprising a controller configured to provide the electrical signal to the electro-mechanical valve.

11. The hydraulic fluid system of claim 10, further comprising a sensor device coupled to the controller, the sensor providing a signal to the controller relating to one of temperature, atmospheric pressure, and altitude.

12. The hydraulic fluid system of claim 7, wherein the blocking valve is configured to be biased as closed between the inlet and the outlet.

13. The hydraulic fluid system of claim 7, electro-mechanical valve is configured to be biased toward the second fluid path.
